(19) United States
(12) Patent Application Publication
(10) Pub. No.: US 2008/0015298 A1
(43) Pub. Date: Jan. 17, 2008

(54) Superhydrophobic coating composition and coated articles obtained therefrom

(76) Inventors: Mingna Xiong, Shanghai (CN); Judith Stein, Schenectady, NY (US); Liping Zheng, Shanghai (CN); Hui Lei, Shanghai (CN); Jun Xiao, Shanghai (CN); Tao Deng, Clifton Park, NY (US); Yanrong Zhu, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/487,004

(22) Filed: Jul. 17, 2006

(51) Int. Cl. C08K 3/22

(52) U.S. Cl. 524/432; 524/445; 524/451; 524/493

(57) ABSTRACT

A coating composition is provided comprising: (i) a fluorinated polymer comprising (a) structural units having the formula (I):

—CR¹R²—CFX— (I)

wherein R¹ and R² are each independently an alkyl group, a fluorine atom, a chlorine atom, a hydrogen atom or a trifluoromethyl group, and X is a fluorine atom, a chlorine atom, a hydrogen atom or a trifluoromethyl group, and (b) structural units comprising at least one type of crosslinkable functional group; (ii) a crosslinking agent; and (iii) a plurality of particles functionalized with a functional group, wherein the functional group on the particles is essentially non-reactive with the fluorinated polymer and with the crosslinking agent. Articles comprising a coating composition described in embodiments of the invention are also provided.

### BACKGROUND

The invention relates generally to a superhydrophobic coating composition. More particularly, the invention relates to a superhydrophobic coating composition comprising a fluorinated polymer and a plurality of functionalized particles. The invention also relates to a coated article comprising the superhydrophobic coating composition.

Hydrophobic and superhydrophobic surfaces are desirable in numerous applications, such as windows, DVD disks, cooking utensils, clothing, medical instruments, automotive parts, textiles, and like applications, and also other applications in which self-cleaning is desired. Typically superhydrophobic surfaces are created by changing the surface chemistry or by increasing the surface roughness via surface texturing so as to increase the true or effective surface area or by combining both of these methods. Surface texturing may be cumbersome, expensive, and may be difficult to achieve for large and complex articles. Chemical methods typically involve coating the surface with a superhydrophobic coating, layer or a film. Coating the surface with a superhydrophobic coating is a very efficient means of converting any surface into a superhydrophobic surface. However, most of such superhydrophobic coatings suffer from poor adhesion to the surface, lack mechanical robustness, and are prone to scratches. In spite of much effort, there is a need for superhydrophobic coatings with controlled hydrophobicity and good durability.

### BRIEF DESCRIPTION

The present invention meets these and other needs by providing a superhydrophobic coating with good integrity.

Accordingly, in one exemplary embodiment of the invention, there is provided a coating composition comprising: (i) a fluorinated polymer comprising

(a) structural units having the formula (I):

—CR¹R²—CFX— (I)

wherein R¹ and R² are each independently an alkyl group, a fluorine atom, a chlorine atom, a hydrogen atom or a trifluoromethyl group, and X is a fluorine atom, a chlorine atom, a hydrogen atom or a trifluoromethyl group, and (b) structural units comprising at least one type of crosslinkable functional group; (ii) a crosslinking agent; and (iii) a plurality of particles functionalized with a functional group, wherein the functional group on the particles is essentially non-reactive with the fluorinated polymer and with the crosslinking agent.

In another exemplary embodiment of the invention, there is provided coating composition comprising (i) a fluorinated polymer comprising structural units derived from at least one monomer selected from the group consisting of CF₂═CF₂, CHF═CF₂, CH₂═CF₂, CH₂═CHF, CClF═CF₂, CCl₂═CF₂, CClF═CClF, CHF═CCl₂, CH₂═CClF, CCl₂═CClF, CH₂═C(CF₃)₂, CF₃CF═CF₂, CF₃CF═CHF, CF₃CH═CF₂, CF₃CH═CH₂, CHF₂CF═CHF, CHF₂CH═CHF, CHF₂CH═CH₂, and mixtures thereof, and further comprising structural units comprising a crosslinkable hydroxyl functional group; (ii) a crosslinking agent comprising an isocyanate; and (iii) a plurality of silica particles or polyorganosilsesquioxane particles functionalized with a fluoro group or an alkyl group; wherein the polymer comprises a fluorine content in a range from about 5 wt. % to about 60 wt. %, a hydroxyl value in a range from about 10 mg KOH/g to about 100 mg KOH/g, and an acid value in a range from about 0 mg KOH/g to about 15 mg KOH/g, wherein the coating, after coating onto a surface, has a wettability sufficient to generate, with a reference fluid, a static contact angle of greater than about 120 degrees.

In yet another embodiment of the invention, there is provided an article comprising a coating composition comprising: (i) a fluorinated polymer comprising (a) structural units having the formula (I):

—CR¹R²—CFX— (I)

wherein R¹ and R² are each independently an alkyl group, a fluorine atom, a chlorine atom, a hydrogen atom or a trifluoromethyl group, and X is a fluorine atom, a chlorine atom, a hydrogen atom or a trifluoromethyl group, and (b) structural units comprising at least one type of crosslinkable functional group; (ii) a crosslinking agent; and (iii) a plurality of particles functionalized with a functional group, wherein the functional group on the particles is essentially non-reactive with the fluorinated polymer and with the crosslinking agent.

In yet another embodiment of the invention, there is provided an article comprising a coating composition comprising (i) a fluorinated polymer comprising structural units derived from at least one monomer selected from the group consisting of CF₂═CF₂, CHF═CF₂, CH₂═CF₂, CH₂═CHF, CClF═CF₂, CCl₂═CF₂, CClF═CClF, CHF═CCl₂, CH₂═CClF, CCl₂═CClF, CH₂═C(CF₃)₂, CF₃CF═CF₂, CF₃CF═CHF, CF₃CH═CF₂, CF₃CH═CH₂, CHF₂CF═CHF, CHF₂CH═CHF, CHF₂CH═CH₂, and mixtures thereof, and further comprising structural units comprising a crosslinkable hydroxyl functional group; (ii) a crosslinking agent comprising an isocyanate; and (iii) a plurality of silica particles or polyorganosilsesquioxane particles functionalized with a fluoro group or an alkyl group; wherein the polymer comprises a fluorine content in a range from about 5 wt. % to about 60 wt. %, a hydroxyl value in a range from about 10 mg KOH/g to about 100 mg KOH/g, and an acid value in a range from about 0 mg KOH/g to about 15 mg KOH/g, wherein the coating has a wettability after coating onto a surface sufficient to generate, with a reference fluid, a static contact angle of greater than about 120 degrees.

### BRIEF DESCRIPTION OF DRAWINGS

These and other features, aspects, and advantages of the present invention will become better understood when the following detailed description is read with reference to the accompanying drawings wherein:

FIG. 1 is a schematic of a water droplet on a superhydrophobic surface;

FIG. 2 shows cross sectional scanning electron micrographs of coatings with different particle loading according to some embodiments of the invention;

FIG. 3 shows cross sectional scanning electron micrographs of coatings with and without particle functionalization according to some embodiments of the invention; and

FIG. 4 shows optical micrographs of coatings before and after the abrasion test on coatings according to one embodiment of the invention.

### DETAILED DESCRIPTION

In the following specification and the claims that follow, reference will be made to a number of terms, which shall be defined to have the following meanings. The singular forms “a”, “an” and “the” include plural referents unless the context clearly dictates otherwise.

In one embodiment the invention provides a coating composition. The coating composition comprises: (i) a fluorinated polymer comprising structural units comprising at least one type of crosslinkable functional group; (ii) a crosslinking agent; and (iii) a plurality of particles functionalized with a functional group. Although the invention is not limited by any theory of operation, fluorinated polymers are typically hydrophobic and contribute to the hydrophobicity of the composition and the particles dispersed within the composition contribute to the texturing required to obtain high contact angle for a liquid droplet, such as water, on a surface coated with a composition of the invention. The composition of the coating, size and volume fraction of the particles, and various other parameters may be varied to modify the contact angle and the coating integrity.

In one embodiment the fluorinated polymer comprises structural units having the formula (I):

—CR¹R²—CFX— (I)

wherein R¹ and R² are each independently an alkyl group, a fluorine atom, a chlorine atom, a hydrogen atom or a trifluoromethyl group, and X is a fluorine atom, a chlorine atom, a hydrogen atom or a trifluoromethyl group. Some representative monomers from which the structural unit (I) may be derived comprise CF₂═CF₂, CHF═CF₂, CH₂═CF₂, CH₂═CHF, CClF═CF₂, CCl₂═CF₂, CClF═CClF, CHF═CCl₂, CH₂═CClF, CCl₂═CClF, CH₂═C(CF₃)₂, CF₃CF═CF₂, CF₃CF═CHF, CF₃CH═CF₂, CF₃CH═CH₂, CHF₂CF═CHF, CHF₂CH═CHF, CHF₂CH═CH₂, and the like, and mixtures thereof. In some particular embodiments monomers from which the structural unit (I) may be derived comprise tetrafluoroethylene, chlorotrifloroethylene, vinylidene fluoride, hexafluoropropylene, trifluoroethylene or the like, or mixtures thereof.

The fluorinated polymer comprises structural units comprising at least one type of crosslinkable functional group. Examples of suitable crosslinkable functional groups include, but are not limited to, a hydroxyl group, an amine group, a carboxylic ester, a sulfonyl halide, or a carboxylic acid, or mixtures thereof. In an exemplary embodiment, the crosslinkable functional group comprises a hydroxyl group. In some embodiments, the crosslinking reaction occurs at ambient temperatures and pressures, although heat or a catalyst or both may sometimes be used to accelerate the reaction.

The fluorinated polymer comprises a fluorine content in one embodiment in a range from about 1 wt. % to about 70 wt. %, in another embodiment in a range from about 1 wt. % to about 60 wt. %, in another embodiment in a range from about 5 wt. % to about 60 wt. %, in another embodiment in a range from about 10 wt. % to about 60 wt. %, and in still another embodiment in a range from about 20 wt. % to about 60 wt. %. In some particular embodiments the polymer comprises a fluorine content in a range from about 20 wt. % to about 35 wt. %. The fluorinated polymer also exhibits a hydroxyl value in one embodiment in a range from about 1 milligrams potassium hydroxide per gram (mg KOH/g) to about 800 mg KOH/g, in another embodiment in a range from about 10 mg KOH/g to about 400 mg KOH/g, and in still another embodiment in a range from about 10 mg KOH/g to about 200 mg KOH/g. In some particular embodiments, the polymer exhibits a hydroxyl value in a range from about 10 mg KOH/g to about 100 mg KOH/g, in other particular embodiments in a range from about 35 mg KOH/g to about 100 mg KOH/g, and in other particular embodiments in a range from about 35 mg KOH/g to about 60 mg KOH/g. The fluorinated polymer further exhibits an acid value in one embodiment in a range from about 0 mg KOH/g to about 100 mg KOH/g, in another embodiment in a range from about 0 mg KOH/g to about 50 mg KOH/g, and in still another embodiment in a range from about 0 mg KOH/g to about 30 mg KOH/g. In some particular embodiments, the polymer exhibits an acid value in a range from about 0 mg KOH/g to about 15 mg KOH/g, and in other particular embodiments in a range from about 3 mg KOH/g to about 15 mg KOH/g.

Illustrative examples of monomers from which crosslinkable functional groups may be derived comprise an unsaturated carboxylate ester, an unsaturated carboxylic acid, a vinyl ester, a hydroxylated vinyl derivative such as an allyl alcohol, a vinyl alcohol, a propenol, a butenol, 2-hydroxy-ethyl-methacrylate, or a hydroxyalkyl vinyl ether or hydroxyalkyl allyl ether represented by the formula (II):

CH₂═CHR¹ (II)

wherein R¹ is —OR² or —CH₂OR² in which R² is an alkyl group having a hydroxyl group. In one embodiment a preferred substitutent R² is a linear or branched alkyl group of 1 to 8 carbon atoms to which 1 to 3, preferably one, hydroxyl groups are bonded. Illustrative examples of monomers of the formula (II) comprise 2-hydroxyethyl vinyl ether, 3-hydroxypropyl vinyl ether, 2-hydroxypropyl vinyl ether, 2-hydroxy-2-methylpropyl vinyl ether, hydroxybutyl vinyl ether, 4-hydroxybutyl vinyl ether, 4-hydroxy-2-methylbutyl vinyl ether, 5-hydroxypentyl vinyl ether, 6-hydroxyhexyl vinyl ether, 2-hydroxyethyl allyl ether, hydroxybutyl allyl ether, 4-hydroxybutyl allyl ether, glycerol monoallyl ether, or the like. Analogs of monomers with crosslinkable functional groups which are fluorinated or alkylated or both may also be employed. Mixtures comprising two or more monomers with crosslinkable functional groups may be employed in some embodiments.

Monomers having ester moieties in the side chains comprise those represented by the formula (III):

CHR³═CHR⁴ (III)

wherein, R³ is a hydrogen atom, an alkyl group, or —COOR⁵, R⁴ is —COOR⁵ or —OCOR⁵, in which R⁵ is an alkyl group, a cycloalkyl group, a fluoroalkyl group, an arylalkyl group or an aryl group which may be substituted by an alkyl group; provided that when R⁴ is —OCOR⁵, R³ is a hydrogen atom. Preferred examples of the monomer comprise a vinyl carboxylate represented by the formula (IV):

CH₂═CH(OCOR⁵) (IV)

or a diester of maleic acid or fumaric acid represented by the formula (V):

(R⁵OOC)CH═CH(COOR⁵) (V)

wherein R⁵ is as defined above. Illustrative examples of the substitutent R⁵ comprise an alkyl group of 1 to 10 carbon atoms, a cycloalkyl group of 3 to 10 carbon atoms, a fluoroalkyl group of 1 to 10 carbon atoms, an arylalkyl group of 1 to 10 carbon atoms, and an aryl group which may be substituted by an alkyl group of 1 to 8 carbon atoms.

Illustrative examples of the vinyl carboxylate of the formula (IV) comprise vinyl acetate, vinyl propionate, vinyl butyrate, vinyl isobutyrate, vinyl pivalate, vinyl caproate, vinyl versatate, vinyl laurate, vinyl stearate, vinyl benzoate, vinyl p-tert-butylbenzoate, vinyl salicylate, vinyl cyclohexanecarboxylate, vinyl hexafluoropropionate, vinyl trichloroacetate, or the like, or mixtures thereof. Illustrative examples of the diester of a dicarboxylic acid of the formula (V) comprise dimethyl, diethyl, dipropyl, dibutyl, diphenyl, dibenzyl, ditrityl, ditrifluoromethyl, ditrifluoroethyl or dihexafluoropropyl esters of maleic acid or fumaric acid, or the like, or mixtures thereof.

Optionally, structural units derived from a copolymerizable monomer other than the above monomers may be incorporated in an amount of not more than about 45%, and preferably not more than about 15% in order to endow the copolymer with various properties of the other copolymerizable monomers without impairing the characteristic properties of the fluorine-containing copolymer. Illustrative examples of such optional other monomers comprise alkyl vinyl ethers such as methyl vinyl ether, ethyl vinyl ether, n-propyl vinyl ether, isopropyl vinyl ether, n-butyl vinyl ether, isobutyl vinyl ether, tert-butyl vinyl ether, n-pentyl vinyl ether, n-hexyl vinyl ether, n-octyl vinyl ether, 2-ethylhexyl vinyl ether, 2-acetoxyethyl vinyl ether or 2-chloroethyl vinyl ether; cycloalkyl vinyl ethers such as cyclopentyl vinyl ether, cyclohexyl vinyl ether, methylcyclohexyl vinyl ether and cyclooctyl vinyl ether; aromatic vinyl ethers such as benzyl vinyl ether, phenetyl vinyl ether, phenyl vinyl ether, 2-phenoxyethyl vinyl ether or 2-vinyloxyethyl benzoate; fluoroalkyl vinyl ethers such as 2,2,2-trifluoroethyl vinyl ether, 2,2,3,3-tetrafluoropropyl vinyl ether, 2,2,3,3,3-pentafluoropropyl vinyl ether, 2,2,3,3,4,4,5,5-octafluoropentyl vinyl ether, 2,2,3,3,4,4,5,5,6,6,7,7,8,8,9,9-hexadecafluorononyl vinyl ether, perfluoromethyl vinyl ether, perfluoroethyl vinyl ether or perfluoropropyl vinyl ether; or the like, or fluoroalkylethylenes of the formula (VI), wherein the parameter “x” has a value between 0 and 10 inclusive:

CH₂═CH(CF₂)ₓCF₃ (VI)

Further, fluorinated polymers in embodiments of the invention may optionally comprise structural units derived from C₁₋₁₈ alkyl esters of acrylic or methacrylic acid such as methyl acrylate, ethyl acrylate, propyl acrylate, isopropyl acrylate, butyl acrylate, hexyl acrylate, octyl acrylate, lauryl acrylate, methyl methacrylate, ethyl methacrylate, propyl methacrylate, isopropyl methacrylate, butyl methacrylate, hexyl methacrylate, octyl methacrylate, trityl methacrylate and lauryl methacrylate; C₂₋₁₈ alkoxyalkyl esters of acrylic or methacrylic acid such as methoxybutyl acrylate, methoxybutyl methacrylate, methoxyethyl acrylate, methoxyethyl methacrylate, ethoxybutyl acrylate or ethoxybutyl methacrylate; or vinyl aromatic compounds such as styrene, alpha-methylstyrene, vinyltoluene, or p-chlorostyrene or the like, or mixtures thereof.

In other embodiments fluorinated polymers in embodiments of the invention may optionally comprise structural units derived from one or more monomers comprising a carboxyl group. Illustrative monomers having a carboxyl group comprise carboxyl group-containing vinyl monomers represented by the formula (VII):

R⁶R⁷C═CR(CH₂)_{y}CO₂H (VII)

wherein R⁶, R⁷ and R⁸ are the same or different, and each is independently a hydrogen atom, a fluorine atom, an alkyl group, an aryl group, a carboxyl or an ester group, and y has a value in a range from 0 to about 10, and preferably in a range from 0 to about 8; or represented by the formula (VIII):

CH₂═CH(CH₂)ₘO(R⁹OCO)ₙR¹⁰CO₂H (VIII)

wherein R⁹ and R¹⁰ are same or different, and each is a linear or cyclic alkyl which may be saturated or unsaturated, n is 0 or 1, and m is 0 or 1. Illustrative examples of such monomers comprise acrylic acid, methacrylic acid, vinylacetic acid, crotonic acid, cinnamic acid, 3-allyloxypropionic acid, itaconic acid, a monoester of itaconic acid, maleic acid, a monoester of maleic acid, maleic acid anhydride, fumaric acid, a monoester of fumaric acid, vinylphthalic acid, phthalic acid monovinyl ester, vinyl pyromellitate, pyromellitic acid monovinyl ester, undecylenic acid, or the like.

In still other embodiments fluorinated polymers in embodiments of the invention may optionally comprise structural units derived from one or more monomers represented by the formula (IX):

CFX═CXOCF₂OR¹¹ (IX)

wherein X is a fluorine atom or a hydrogen atom, and R¹¹ is a C₂-C₆ linear, branched or C₅-C₆ cyclic perfluoroalkyl group, or a C₂-C₆ linear or branched perfluoro oxyalkyl group containing from one to three oxygen atoms. When R¹¹ is a fluoroalkyl or fluorooxyalkyl group as above defined, it can contain 1 or 2 atoms, the same as or different from each other, selected from the group consisting of a hydrogen atom, a chlorine atom, a bromine atom, and an iodine atom. In a particular embodiment a suitable monomer of the formula (IX) is represented by the formula (X):

CFX═CXOCF₂OCF₂CF₂Y (X)

where Y is a fluorine atom, a hydrogen atom, or OCF₃.

In still other embodiments the fluorinated polymer may optionally comprise structural units derived from a beta-methyl substituted alpha-olefin monomer and represented by the formula (XI):

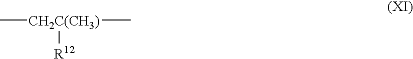

wherein R¹² is an alkyl group having 1 to 8 carbon atoms. Monomers from which the structural unit (XI) may be derived comprise isobutylene, 2-methyl-1-butene, 2-methyl-1-pentene, 2-methyl-1-hexene or the like or mixtures thereof.

Copolymers comprising a polymer block comprising structural units of a fluorinated polymer described in embodiments of the invention in combination with an additional polymeric block comprising at least one type of structural unit different from those structural units of the fluorinated polymer or an amount of structural unit different from that of structural units of the fluorinated polymer are also encompassed within the invention. In some embodiments preferred examples of suitable fluorinated polymers comprise fluorinated ethylene vinyl esters or fluorinated ethylene vinyl ethers (sometimes referred to as FEVE resins), or mixtures thereof. In some embodiments suitable fluorinated polymers comprise fluorinated polymer available from Xuzhou Zhongyan Fluoro Chemical Co., Ltd (China) under the trade name ZY-2; fluorinated polymer available from Asahi Glass Co. under the trade name LUMIFLON®; fluorinated polymer available from Qingdao Hongfen Group Co. under the trade name HFS-F-3000; fluorinated polymers available from Daikin under the trade name ZEFFLE GK®; and fluorinated polymers available from Central Glass Co. (Tokyo, Japan) under the trade names CEFRAL COAT® and CEFRAL SOFT®. Additional examples of suitable fluorinated polymers comprise those described in U.S. Pat. Nos. 4,151,340, 4,345,057, 4,634,754, 5,169,915, and 6,794,469, and in U.S. published patent application Serial No. 2005/0192420.

As used herein the term “cycloaliphatic” or “cycloalkyl” radical refers to a radical having a valence of at least one, and comprising an array of atoms which is cyclic but which is not aromatic. A “cycloaliphatic radical” may comprise one or more noncyclic components. For example, a cyclohexylmethyl group (C₆H₁₁CH₂—) is an cycloaliphatic radical which comprises a cyclohexyl ring and a methylene group (the noncyclic component). The cycloaliphatic radical may comprise heteroatoms such as nitrogen, sulfur, selenium, silicon, phosphorus, and oxygen, or may be composed exclusively of carbon and hydrogen. For convenience, the term “cycloaliphatic radical” as defined herein may comprise a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms, which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis(cyclohex-4-yl) (i.e., —C₆H₁₀C(CF₃)₂C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g., CH₃CHBrCH₂C₆H₁₀O—), and the like. Further examples of cycloaliphatic radicals include 4-allyloxycyclohex-1-yl, 4-aminocyclohex-1-yl (i.e., H₂NC₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —OC₆H₁₀(CH₂)₆C₆H₁₀O—), 4-hydroxymethylcyclohex-1-yl (i.e., 4-HOCH₂C₆H₁₀—), 4-mercaptomethylcyclohex-1-yl (i.e., 4-HSCH₂C₆H₁₀O—), 4-methylthiocyclohex-1-yl (i.e., 4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g., (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein the term “aliphatic” or “alkyl” radical refers to an organic radical having a valence of at least one consisting of a linear or branched array of atoms, which is not cyclic. Aliphatic radicals are defined to comprise at least one carbon atom. The array of atoms comprising the aliphatic radical may comprise heteroatoms such as nitrogen, sulfur, silicon, selenium, phosphorus, and oxygen or may be composed exclusively of carbon and hydrogen. For convenience, the term “aliphatic radical” as defined herein may comprise, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e., —CHO), hexyl, hexamethylene, hydroxymethyl (i.e., —CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl (i.e., (CH₃)₃Si—), t-butyldimethylsilyl, 3-trimethyoxysilypropyl (i.e., (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH₂)₉—) is an example of a C₁₀ aliphatic radical.

As used herein, the term “aryl” or “aromatic” radical refers to an array of atoms having a valence of at least one comprising at least one aromatic group. The array of atoms having a valence of at least one comprising at least one aromatic group may comprise heteroatoms such as nitrogen, sulfur, selenium, silicon, phosphorus, and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4ₙ₊₂ “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthracenyl groups (n=3) and the like. The aromatic radical may also include nonaromatic components. For example, a benzyl group is an aromatic radical, which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” as defined herein may comprise a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical is a C₆ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-trichloromethylphen-1-yl (i.e., 3-CCl₃Ph—), 4-(3-bromoprop-1-yl)phen-1-yl (i.e., 4-BrCH₂CH₂CH₂Ph—), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃SPh-), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphenl-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₇—) represents a C₆ aromatic radical.

Suitable crosslinking agents include, but are not limited to, an isocyanate compound, a divinyl compound, an ester compound, an acid halide compound, a sulfonyl halide compound, an organosilane, an epoxy compound, an oxetanyl compound, an oxazolyl compound, an amino compound, a mercapto compound, a β-ketoester compound, a hydrosilyl compound, a silanol compound, and a sulfonyl ester compound. The specific crosslinking agent used in the composition depends on the crosslinkable functional group available in the fluorinated polymer. The linking group between the fluorinated polymer and the crosslinking agent may be a covalent bond, divalent alkylene, or a group that can result from the condensation reaction of a nucleophile such as an alcohol, an amine, or a thiol with an electrophile, such as an ester, acid halide, isocyanate, sulfonyl halide, sulfonyl ester, or may result from a displacement reaction between a nucleophile and leaving group. Additional illustrative examples of suitable linking groups include straight chain, branched chain, or cyclic alkylene, arylene, aralkylene; oxy, oxo, hydroxy, thio, sulfonyl, sulfoxy, amino, imino, sulfonamido, carboxamido, carbonyloxy, urethanylene, urylene, and combinations thereof such as sulfonamidoalkylene. In one embodiment the linking group is a covalent bond. In some embodiments when the crosslinkable functional group in the fluorinated polymer comprises a nucleophilic group such as an amine or a hydroxyl group, then crosslinking agents comprising electrophilic groups such as an isocyanate or an epoxide may be suitable for use. In one embodiment the crosslinking agent comprises an isocyanate compound. In another embodiment the isocyanate is a polyisocyanate. In still another embodiment the crosslinking agent is a compound having the formula of R¹(NCO)ₓ, where x is an integer in a range from 2 to 6 and R¹ is an aliphatic, alicyclic, or an aromatic group.

In certain embodiments the polyfunctional isocyanate compounds contain an average of two to six isocyanate (—NCO) radicals. Compounds containing at least two —NCO radicals are comprised of aliphatic, alicyclic, araliphatic, or aromatic groups to which the —NCO radicals are attached. Representative examples of suitable isocyanate compounds also comprise isocyanate functional derivatives or adducts of isocyanate compounds. Examples of such derivatives include, but are not limited to, those selected from the group consisting of ureas, biurets, allophanates, dimers, trimers (such as uretdiones and isocyanurates) or polymers of isocyanate compounds, and mixtures thereof. Any suitable organic polyisocyanate, such as an aliphatic, alicyclic, araliphatic, or aromatic polyisocyanate, may be used either singly or in mixtures of two or more. The aliphatic polyisocyanate compounds generally provide better light stability than the aromatic compounds. Aromatic polyisocyanate compounds, on the other hand, are generally more economical and reactive toward polyols than are aliphatic polyisocyanate compounds. Suitable aromatic polyisocyanate compounds comprise 2,4-toluene diisocyanate (TDI), 2,6-toluene diisocyanate, an adduct of TDI with trimethylolpropane (available as DESMODUR® CB from Bayer Corporation, Pittsburgh, Pa.), the isocyanurate trimer of TDI (available as DESMODUR® IL from Bayer Corporation, Pittsburgh, Pa.), diphenylmethane-4,4′-diisocyanate (MDI), diphenylmethane-2,4′-diisocyanate, 1,5-diisocyanato-naphthalene, 1,4-phenylene diisocyanate, 1,3-phenylene diisocyanate, 1-methoxy-2,4-phenylene diisocyanate, 1-chlorophenyl-2,4-diisocyanate, or the like, or mixtures thereof.

Examples of useful alicyclic polyisocyanate compounds comprise dicyclohexylmethane diisocyanate (H₁₂MDI, commercially available as DESMODUR® W from Bayer Corporation, Pittsburgh, Pa.), 4,4′-isopropyl-bis(cyclohexylisocyanate), isophorone diisocyanate (IPDI), cyclobutane-1,3-diisocyanate, cyclohexane-1,3-diisocyanate, cyclohexane-1,4-diisocyanate (CHDI), 1,4-cyclohexanebis(methylene isocyanate) (BDI), dimer acid diisocyanate, 1,3-bis(isocyanatomethyl)cyclohexane (H₆XDD), methyl cyclohexyl diisocyanate, 3-isocyanatomethyl-3,5,5-trimethylcyclohexyl isocyanate, or the like, or mixtures thereof.

Examples of useful aliphatic polyfunctional isocyanate compounds include, but are not limited to, tetramethylene-1,4-diisocyanate, n-pentane-1,4-diisocyanate, hexamethylene-1,4-diisocyanate, hexamethylene-1,6-diisocyanate (HDI), octamethylene-1,8-diisocyanate, 1,12-diisocyanatododecane, 2,2,4-trimethyl-hexamethylene diisocyanate (TMDI), 2-methyl-1,5-pentamethylene diisocyanate, dimer diisocyanate, the urea of hexamethylene diisocyanate, the biuret of hexamethylene-1,6-diisocyanate (HDI) (available as DESMODUR® N-100 and N-3200 from Bayer Corporation, Pittsburgh, Pa.), the isocyanurate of HDI (available as DESMODUR® N-3300 and DESMODUR® N-3600 from Bayer Corporation, Pittsburgh, Pa.), a blend of the isocyanurate of HDI and the uretdione of HDI (available as DESMODUR® N-3400 from Bayer Corporation, Pittsburgh, Pa.), lysine methyl ester diisocyanate, or the like, or mixtures thereof.

Examples of useful araliphatic polyisocyanates include, but are not limited to, those selected from the group consisting of m-tetramethyl xylylene diisocyanate (m-TMXDI), p-tetramethyl xylylene diisocyanate (p-TMXDI), 1,4-xylylene diisocyanate (XDI), 1,3-xylylene diisocyanate, p-(1-isocyanatoethyl)phenyl isocyanate, m-(3-isocyanatobutyl)phenyl isocyanate, 4-(2-isocyanatocyclohexyl-methyl)phenyl isocyanate, or the like, or mixtures thereof.

Preferred polyisocyanates comprise those selected from the group consisting of the biuret of hexamethylene-1,6-diisocyanate, tetramethylene-1,4-diisocyanate, hexamethylene-1,4-diisocyanate, hexamethylene-1,6-diisocyanate (HDI), octamethylene-1,8-diisocyanate, 1,12-diisocyanatododecane, octadecylisocyanate, or the like, or mixtures thereof. Blocked isocyanates may also be used.

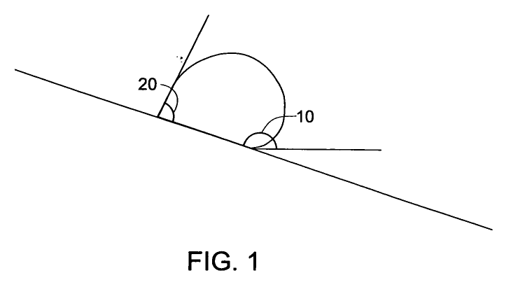

The coating composition typically comprises a plurality of particles. The particles may serve as surface roughening agents in embodiments of the present invention. The surface roughness and hence the contact angle for a liquid droplet, such as water, on a surface coated with a composition of the invention depends upon such factors as the particle size and the particle shape of the particles used in the coating composition. As used herein, static contact angle or simply termed contact angle (CA) is the angle encompassed by the surface and a tangent along the surface of the liquid drop in the region of the contact point of the liquid drop with the surface, the contact angle being measured through the liquid drop. The contact angle of the leading edge of the droplet represents the largest measurable contact angle and is termed the advancing contact angle. The contact angle of the receding edge of the droplet represents the minimum measurable contact angle and is termed the receding contact angle. The difference between the advancing and receding contact angles is termed the contact angle hysteresis. FIG. 1 shows schematically the advancing angle 10 and receding angle 20 marked for a water droplet on a superhydrophobic surface. The exact contact angle depends on the reference liquid used. In certain embodiments of the invention, the reference liquid is water. A contact angle of 0° denotes complete wettability and no drop formation, whereas a contact angle of 180° denotes complete unwettability. Roll-off angle (RA) is the smallest possible angle of inclination of the surface under test, with respect to the horizontal, which is sufficient to cause the liquid drop to move away from this surface. RA and hysteresis of a water droplet indicates the stability of the droplet on the surface; the lower the value for these two parameters, the less the stability of the droplet and therefore, the easier the roll-off of the droplet from the surface.

The optimum particle size depends on the particle loading in the polymer matrix. For example, the particles may be micron-sized particles or nanoparticles. Micron-sized particles are defined herein as those powders or particles having a median particle size of from sizes up to about 100 microns. Nanoparticles are defined herein as those powders or particles having a median particle size of 1 nanometer up to about 500 nanometers. In some embodiments particles have a median particle size of about 10 microns or less. In certain embodiments the particles have a bimodal particle size distribution, implying the particles have two distinct classes of particle sizes. The particles may also be in the form of rods, or fibers or any other various shapes, sizes, or aspect ratios.

The particles used in the coating composition may comprise a ceramic, a polymer, a semiconducting material, a polyorganosilsesquioxane, a metal, a metal oxide, natural or synthetic minerals, natural or synthetic clays, an inorganic material, or a glass particle. Some examples of suitable materials include, but are not limited to, metal oxides such as silica, titania, zinc oxide, alumina, zirconia, vanadia, chromia, ceria, iron oxide, antimony oxide, and tin oxide, boron nitride, aluminosilicates, talc, graphite, carbon black, hydrolyzed graphite, and mixtures thereof. In one embodiment the oxide particle is silica particle that is typically derived from a colloidal silica dispersion, fumed silica, or a precipitated silica. The silica particles can be pure silica or can be partly composed of other elements such as aluminum. Silica particles provide the advantages of excellent performance in water-spreading layers, low cost, UV light resistance, and compatibility with other polymers. In certain embodiments the silica particles are impregnated with alumina or an aluminum salt.

In certain embodiments the particles comprise a polymer. Suitable polymer particles include, but are not limited to, crosslinked polylolefins, crosslinked copolymers of polyolefins and styrene, crosslinked polybutadiene, crosslinked polystyrene, polytetrafluoroethylene, polypropylene, polyethylene, poly(fluorinated ethylene vinyl ether), fluorinated polyacrylate, fluorinated polyether, fluorinated polyurethane, fluorinated epoxy resin, fluorinated silicone, fluorinated alkyd resin, fluorinated polyurea, fluorinated formaldehyde phenol resin, or like polymers. In other embodiments the particles comprise a polyorganosilsesquioxane or like material.

In other particular embodiments the particles comprise a metal. Examples of suitable metals include, but are not limited to, aluminum, silver, zinc, iron, and copper. In another embodiment the particle may comprise a metal alloy, such as but not limited to steel.

Typically, the particles used in the coating composition are functionalized with a functional group. The functional group is essentially non-reactive with the polymer matrix and with the crosslinking agent. In certain embodiments the functional group is a hydrophobic functional group. The examples of suitable functional groups include, but are not limited to, a fluoro group, an alkyl group, a cycloalkyl group, an aryl group, or a silyl group. In an exemplary embodiment the functional group comprises a fluoro group. The functionalization of the particles typically modifies the microstructure of the coating and hence may affect the contact angle for a liquid droplet, such as water, on a surface coated with a composition of the invention. It is believed that certain functionalization of particles may result in hierarchical microstructure and that such a microstructure, among other factors may contribute to a high contact angle. In the present context a hierarchical microstructure connotes a plurality of features comprising features with one characteristic dimension disposed on features with characteristic dimension of another magnitude. Illustrative examples of functionalizing agents which may be used to impart functionality to particle surfaces in embodiments of the invention comprise n-octyldimethylchlorosilane, n-octylmethyldichlorosilane, tridecafluoro-1,1,2,2-tetrahydrooctyl)methyldichlorosilane, tridecafluoro-1,1,2,2-tetrahydrooctyl)dimethylchlorosilane, tridecafluoro-1,1,2,2-tetrahydrooctyl)triethoxy silane, tridecafluoro-1,1,2,2-tetrahydrooctyl)methyldimethoxysi lane, n-octyltrimethoxysi lane, hexamethyldisilazane, and like reagents, and mixtures thereof.

In some embodiments the particles are modified by contacting with a chemical modifying reagent capable of reacting with the particles to form functional groups on the particle surfaces. The particles may be contacted with the chemical modifying reagent prior to the formation of the mixture comprising the particle and the polymer composition. Alternatively, the chemical modifying reagent may be included in the mixture comprising the particle and the polymer composition. The functionalization of the particles may also be done using any process known in the art.

The particle loading affects the contact angle and the coating integrity. In one embodiment the particles are employed in the coating composition at 1% to 80% by volume, in another embodiment at 20% to 70% by volume, and in yet another embodiment about 30% to 50% by volume, based on the total volume of the coating composition. The coating composition may further optionally comprise various additives such as, but not limited to, pigments, dyes, stabilizers, absorbers, antioxidants, processing aids, surfactants, at least one additional polymer, and the like added for the purpose of enhancing the practical utility, if necessary.

Coating compositions in embodiments of the invention may comprise aqueous suspensions, emulsions, or solutions, or organic solvent (or organic solvent/water) solutions, suspensions, or emulsions of the fluorinated polymer, and one or more of the crosslinking agent, and the functionalized particle. When applied as coatings, the coating compositions of the present invention impart superhydrophobicity, oil- and water-repellency properties, and/or stain-release and stain-resistance characteristics to any of a wide variety of substrates. Representative substrates comprise any that would benefit from having a coating composition as described in embodiments of the present invention. Illustrative examples of suitable substrates comprise a glass, a ceramic, an inorganic material, a metal, an organic material, a polymeric material, a semiconducting material, a bioorganic material, a composite material, or an inorganic-organic hybrid. The substrate surface may be treated, if so desired, to promote adhesion of the coating to the substrate surface. Exemplary treatments comprise at least one of corona, flame, ultraviolet, or chemical treatments.

Coating compositions in embodiments of the invention may be dissolved, suspended, or dispersed in a variety of solvents to provide a form suitable for use in coating onto a substrate. Generally, the solvent solutions may contain in one embodiment from about 0.1 to about 60 volume percent solids, in another embodiment from about 0.1 to about 45 volume percent solids, and in still another embodiment from about 0.1 to about 30 volume percent solids. Suitable solvents comprise volatile organic solvents which evaporate, where appropriate through heating, after use of the composition of the invention, e.g. after application of a composition formulated as a coating composition, thus allowing a uniform film of the coating to form. Examples of suitable solvents comprise ketones, such as acetone, ethyl methyl ketone, volatile esters of acetic acid, e.g. ethyl acetate, n-butyl acetate, cyclic ethers, such as tetrahydrofuran, and also aliphatic or aromatic hydrocarbons, such as terpentine oil, petroleum, petroleum spirit, toluene, alcohols, esters, glycol ethers, amides, hydrocarbons, hydrofluorocarbons, hydrofluoroethers, chlorohydrocarbons, chlorocarbons, xylene, water, and various combinations thereof. In some embodiments the solvent is chosen depending upon the substrate upon which the composition is being applied.

The amount of the fluorinated polymer composition (component a), the amount of the crosslinking agent (component b), and the amount of the functionalized particles (component c) applied to a substrate is chosen so that sufficiently high or desirable hydrophobicity is imparted to the substrate surface.

To prepare the coating composition, the fluorinated polymer, together with the crosslinking agent and the particles in an appropriate ratio are vigorously dispersed in a solvent. In the present context an appropriate ratio is in a range which provides a superhydrophobic surface. To facilitate the preparation of the coating solution, the polymeric product may be dissolved first in a solvent or a mixture of solvents, and the dispersion of the particles may be added later. A high-speed stirrer, such as a dispersing machine or an ultrasonic treatment may be applied to enhance the dispersion process. Generally, the coating comprises in one embodiment 0.1 wt. % to about 95 wt. % of the fluorinated polymer and in another embodiment about 10 wt. % to about 50 wt. % of the fluorinated polymer, in one embodiment 0.1 wt. % to about 95 wt. % of the crosslinking agent and in another embodiment about 2 wt. % to about 20 wt. % of the crosslinking agent, and in one embodiment 1 wt. % to about 95 wt. % of particles and in another embodiment about 40 wt. % to about 85 wt. % of particles, based on the weight of solid content of the coating composition. Crosslinking agents are incorporated into the coating compositions, according to embodiments of the present invention. The ratio of the fluorinated polymer to the crosslinking agent may be varied in a wide range depending on the crosslinking agent. In certain embodiments the crosslinking agent may be used in amounts ranging from about 1 wt. % to about 95 wt. %, in other embodiments from about 5 wt. % to about 70 wt. %, and in other embodiments from about 10 wt. % to about 20 wt. %, based on the weight of solid content of the coating composition.

Another embodiment of the present invention is an article comprising the coating composition of the present invention. Particular articles that may be coated on one or more of their surfaces comprise a plastic, a thermoplastic, a thermoset, a sintered material, a woven material, a textured material, a semiconductor, a glass, a ceramic, a metal, a composite, a polymer-comprising composite, a metal-comprising composite, a ceramic-comprising composite, a primed or a pre-coated surface, or the like. The coating may also be used on surfaces which are porous, smooth, rough, pitted, foamed, grooved, cross-hatched, striated, or which have patterned physical features.

The coating composition may be applied to an article using any method known in the art. In one embodiment the method for applying the coating composition comprises dip-coating the article into a coating solution or suspension. Other coating methods may also be used, including spin coating, spray coating, draw-down, tumbling in solution, brush coating, padding, spraying, fogging, transferring, painting, printing, stenciling, screen printing, pad printing, ink jet printing, injection molding, laminating and doctoring. For articles having interior walls defining a reservoir portion, the area of the article around and defining an opening to the reservoir is also coated. For simultaneously coating a large number of small articles, each having a reservoir portion, a tumbling method of coating may be used. According to some embodiments of the invention, one or more coatings of the same or different coating composition may be applied.

The coating compositions of the invention may be applied to the article in essentially any desired thickness. In certain embodiments the coating is as thin as a few microns. In other particular embodiments the coating thickness is in a range from about 5 micrometers to about 200 micrometers, preferably in a range from about 5 micrometers to about 100 micrometers and more preferably in a range from about 20 micrometers to about 50 micrometers. Thicker coatings can be obtained by applying a single thicker coating or by applying successive layers of the coating to the surface of the article. The latter can be done by known methods, such as by applying a layer of the coating composition to the substrate and then drying without extensive curing, for example, by heating the coated substrate for about one minute at about 75° C. Successive layers of the coating can then be applied to dried, but uncured, coatings. This procedure may be repeated until the desired coating thickness is obtained.

In some embodiments of the present invention, after the coating composition has been applied to the surface, the coating may be treated to remove a solvent from the mixture. This treatment may include heating the applied coating to a temperature effective to evaporate the solvent. Typically, the solvent is chosen so that the temperature required for evaporation does not exceed the melting point of the substrate or any other components of the coating composition, or exceed the temperature at which the substrate or any of the other components of the coating decomposes. The heating time will depend on a number of factors such as the thickness of the coating applied to the surface and the components of the coating. Vacuum drying, or a combination of vacuum drying and heating, may be used if the substrate has a low melting point.

After application and curing of the coating composition, the article typically exhibits a durable superhydrophobic surface. The coated surface typically exhibits substantially high contact angle and substantially low roll-off angle. In one embodiment a static contact angle of greater than about 120 degrees is observed. In other embodiments a static contact angle of greater than about 140 degrees or greater than about 150 degrees or greater than about 160 degrees is observed. In one embodiment the roll-off angle is less than about 20 degrees, in another embodiment less than about 10 degrees, and in still another embodiment less than about 5 degrees. The coatings of the embodiments of the invention exhibit surprisingly high coating integrity. The term “coating integrity” as used herein refers to the ability of the coating to remain stable and substantially unchanged when subjected at ambient temperature and pressure to a abrasion test involving a force of approximately 1.3 kg.

Articles having surfaces with controlled wettability are attractive for many applications. Such surfaces may be utilized in making articles that are at least one of superhydrophobic, self-cleaning, biocompatible, non-adhering, or wear resistant. Examples of potential applications for coating compositions and articles as described in embodiments of the present invention include leather, roofs, stadium roofs, facades, windows, garden and balcony furniture, motor vehicles, traffic signs, advertising hoardings, solar installations, coatings for fittings, wet cells, laboratory vessels, window panes, windshields, vehicular surfaces, outdoor furniture, household goods such as bottles and containers, visual signaling devices, video displays, signal transmitters, signal receivers, signal reflectors, radomes, architectural surfaces, outdoor furniture, household goods, kitchen articles, kitchen surfaces, bathroom articles, bathroom surfaces, bathtubs, pools, wall tiles, floor tiles, antennae, microwave antennae, parabolic antennas, dishes, reflectors, high-tension outdoor lines, voltage converters, insulators, signs, scanner windows, lenses, liquid crystal displays, greenhouses, green-house roofs, display screens, mirrors, medical devices, auto, aero or other body panels, easy-to-clean walls and countertops, countertops, toilets, heat exchangers, marine vessels, pipes, turbine blades, power lines, automobile exteriors and interiors, textiles, membranes, scaffolds for tissue engineering, medical implants, dishwashers, marine structures, marine vessels, and ship hulls. Biotechnological applications include, but are not limited to, membrane separation, anti-bacterial surfaces, micro-fluidic channels, and the like. Other illustrative applications for coating compositions and articles as described in embodiments of the invention also comprise hair treatment compositions, for example in the form of hairsprays, packaging for liquids, coatings for materials susceptible to corrosion, such as concrete, including steel-reinforced concrete, wood or metal, the surface finishing of paper, card, or polymer films, coatings for pipes, vessels, tanks, reactors, heat exchangers, evaporators, condensers, pumps, nozzles, atomizers, spray dryers, crystallizers, bottling plants, and storage vessels, coatings as a water- and dirt-repellent finish for fabric which can be used, for example, to produce clothing, tents, marquees, tarpaulins, umbrellas, to line compartments, e.g., motor vehicle interiors, to line seating areas, in the automotive sector, for example. Other exemplary articles include, but are not limited to, airfoils or hydrofoils, aircraft surfaces, pipes and tubing for liquid transport or protein separation columns.

The following examples serve to illustrate the features and advantages offered by embodiments of the present invention, and are not intended to limit the invention thereto. All solvents were purchased from Sinopharm Chemical Reagent Co., Ltd (China). Tetraethylorthosilicate (TEOS) was obtained from Hubei Wuhan University Silicone New Material Co., Ltd (China). Colloidal silica with median particle size of 90 nanometers (solution in isopropanol and weight concentration of particles about 30%) was purchased from Fuso Chemical Co., Ltd. Particle loading in the examples is defined as (weight of particle/density of particle) divided by (weight of particle/density of particle+weight of resin/density of resin). (Tridecafluoro-1,1,2,2-tetrahydrooctyl)methyldichlorosilane and hexamethyldisilazane were purchased from Gelest, Inc. and Aldrich Ltd. respectively. Spherical polyorganosilsesquioxane particles were prepared by base-catalyzed hydrolysis and condensation of alkyltrialkoxysilane as described in GB2216535A. “Fluoropolymer-1” and hexamethylene dilsocyanate (HDI) were supplied by Xuzhou Zhongyan Fluoro Chemical Co., Ltd (China). “Fluoropolymer-2” was ZEFFLE GK-570® supplied by Daikin Industries. All chemicals were used without further purification. Fluoropolymer-1 (trade name: ZY-2) comprised structural units derived from monomers comprising chlorotrifluoroethylene, propenol, undecylenic acid, and vinyl acetate. The characteristics of fluoropolymer-1 are given in Table 1.

TABLE 1

| | |
|---|---|
| Fluorine content | at least 24 wt % ± 0.5 wt % |
| Hydroxyl value (mg KOH/gram) | 45 ± 5 |
| Acid value (mg KOH/gram) | 6 ± 1 |
| Solids content (%) | at least 55 |
| Molecular weight (Mw) | 19,435 (PD = 2.11) |
| Tg (° C.) | 35 ± 5 |
| Decomposition temperature (° C.) | about 235–260 |

Fluoropolymer-2 comprised a hydroxyl-functionalized fluoropolymer with an acid value in a range from about 0 mg KOH/g to about 10 mg KOH/g and a hydroxyl value in a range from about 50 to about 100 mg KOH/g.

### EXAMPLE 1

### Coating Composition of Fluoropolymer

Hexamethylene diisocyanate (HDI; weight ratio of fluoropolymer: HDI=6:1) was dissolved in cyclohexanone and added to fluoropolymer-1, followed by stirring for about 10 minutes to obtain a coating composition. The coating composition was spray coated onto a clean glass substrate and cured at 100° C. for 1 hour. Both contact and roll-off angles of the surface were measured by Optical Contact Angle Meter CAM 200 (KSV) with a mechanical tilting stage. A 6 microliter water droplet was used for the measurement. The data are included in Table 2. The coating integrity was evaluated by cotton swab abrasion test, which was done manually. The cotton swab data helped in differentiating the performance of the coatings. An abrasion mark was created by pressing hard on the sample surface and followed by rubbing along one direction. The force used for the abrasion was kept approximately constant (1.3 kg). After abrasion, each coating was rated 1 to 5 according to the degree of damage. The ratings criteria are as follows: Rating 1—the substrate was exposed; Rating 2-significant amount of material was removed, but substrate not exposed, thick abrasion line could be seen; Rating 3—less material was removed, substrate not exposed, the abrasion line was thinner; Rating 4—abrasion line was very obscure, and hard to see by eye; Rating 5—no abrasion line was observed. Rating 5 implies the best abrasion resistance and rating 1 implies the worst abrasion resistance. The coating integrity measured on the coated sample is included in Table 2.

### EXAMPLE 2

### Coating Composition Comprising Fluoropolymer and Untreated polyorganosilsesquioxane Particles

Polyorganosilsesquioxane particles with median particle size of 1 micron were employed. Fluoropolymer-1 and untreated polyorganosilsesquioxane particles were mixed in the weight ratio of 4:6 by sonication for 30 minutes followed by stirring for another 15 minutes. HDI (weight ratio of fluoropolymer: HDI=6:1) dissolved in cyclohexanone was added to the solution, followed by stirring for about 10 minutes to obtain a coating composition. The coating composition was spray coated onto clean glass substrates and cured at 100° C. for 1 hour. Contact angles (CA) and roll-off angles (RA) and coating integrity were measured as described in the previous example on the coated sample and are included in Table 2.

### EXAMPLE 3

### Coating Composition Comprising Fluoropolymer-1 and Fluorosilane Functionalized polyorganosilsesquioxane

Polyorganosilsesquioxane particles were functionalized by the following process: polyorganosilsesquioxane particles with median particle size of 1 micron, deionized (DI) water, isopropanol and (CH₃CH₂O)₃SiCH₂CH₂(CF₂)₅CF₃ (“F-silane”) were mixed together by mechanical stirring. The weight ratios of H₂O: isopropanol=1:8 and particles:F-silane=1 g:1.8 mmol, while particle loading=10 wt. %. The pH was adjusted to 2.8 by addition of HCl. The mixture was refluxed for 2 hours and then the solvent was exchanged for toluene by rotary evaporation. The product was centrifuged and washed with toluene three times to obtain fluorinated polyorganosilsesquioxane particles. The amount of fluorine on the particles was estimated by X-ray photoelectron spectroscopy (XPS) elemental analysis. Fluoropolymer-1 and fluorinated polyorganosilsesquioxane particles were mixed in the weight ratio of 4:6 by sonication for 30 minutes followed by stirring for another 15 minutes. HDI (weight ratio of fluoropolymer: HDI=6:1) dissolved in cyclohexanone was added to the solution, followed by stirring for about 10 minutes to obtain a coating composition. The coating composition was spray coated onto clean glass substrates and cured at 100° C. for 1 hour. Contact and roll-off angles, and coating integrity were measured on the coated samples as described above and are included in Table 2.

### EXAMPLE 4

### Coating Composition Comprising fluoropolymer-1 and Functionalized Silica Particles

(a) Silica particle synthesis: Separate batches of colloidal silica with median particle sizes of 340 nm and 1450 nm were synthesized as described in W. Stober, A. Fink, and E. Bohn, “Controlled Growth of Monodisperse Silica Spheres in the Micron Size Range”, J. Colloid Interface Sci., vol. 26 (1968) pp. 62-9. A typical process for preparation of 340 nm silica is as follows: 70 milliliters (mL) ethanol and 50 mL ammonia were charged into a 250 mL round bottom flask, and stirred with magnetic stirrer at the speed of around 1000 rpm to ensure good mixing. TEOS (4 mL) was slowly added to the mixture with the help of an addition burette, and the mixture was stirred for another 48 hours to complete hydrolysis and condensation reaction of TEOS. The mixture was centrifuged at a speed of 2000 rpm for 30 min, and precipitated silica particles were washed with distilled water followed by centrifuging again. The same centrifugation-wash procedure was repeated five times. Finally, colloidal silica was dispersed in distilled water for storage. The particle size and particle size distribution were measured by dynamic light scattering. The particles had uniform size and low polydispersivity Before using, colloid silica was centrifuged and redispersed in methylisobutylketone for particle functionalization. The other colloidal silica samples were synthesized in a similar manner.

(b) Colloidal silica particle functionalization: (i) Process for methyl functionalized colloidal silica: A typical process for methyl functionalization of colloidal silica is as follows: 101.0 grams (g) of colloidal silica having a median particle diameter of 340 nm in methylisobutylketone (concentration: 10.7%, pure weight of silica=10.8 gram) was charged into a 250 ml flask, and the flask was immersed into an oil bath maintained at a temperature of 95° C. The mixture was flushed with argon for about 10 minutes and hexamethyldisilazane (12.1 g, 75.0 millimols) was added to the mixture. The mixture was stirred and reacted for 3 hours, then centrifuged at a speed of 8000 rpm. The precipitated silica particles were collected and dispersed with methylisobutylketone with the help of sonication and then the mixture was centrifuged. The centrifugation-dispersion procedure was repeated three times. Finally, the synthesized methyl functionalized colloidal silica was dispersed in methylisobutylketone with the weight concentration of 12.9%. The other methyl functionalized colloidal silicas with particle size of 90 nm and 1450 nm were synthesized by the same procedure.

(ii) Process for fluoro-functionalized colloidal silica: A typical process for preparing fluoro-functionalized colloidal silica (340 nm) is as follows: 100.0 g synthesized colloidal silica in toluene (silica concentration: 12%, pure weight of silica: 12 g) and 100 g dichloromethane were charged into a 250 ml flask; then the mixture was stirred at room temperature, and an excess of 1H,1H,2H,2H-perfluorooctylmethyldichlorosilane ((CH₃)Cl₂Si(CH₂)₂(CF₂)₅CF₃) (3.6 g, 7.8 mmol) was added. The mixture was stirred at room temperature and reacted for about 20 hours, then centrifuged at a speed of 6000 rpm. The precipitated silica particles were collected and dispersed in dichloromethane with the help of ultrasonication, then centrifuged again. The process of centrifugation-dispersion was repeated four times. Finally, the synthesized fluoro-functionalized colloidal silica was dispersed in methylisobutylketone in the weight concentration of 13.7%. Fluoro-functionalized colloidal silica with median particle size of 90 nm and 1450 nm were synthesized by the same procedure. The amount of fluorine on the particles was estimated by XPS elemental analysis.

(c) Coating process: Fluoropolymer-1 and fluorinated silica particles were mixed with the weight ratio of 4:6 by sonication for 30 minutes followed by stirring for another 15 minutes. HDI (weight ratio of fluoropolymer: HDI=6:1) dissolved in cyclohexanone was added to the solution, followed by stirring for about 10 minutes to obtain a coating composition. The coating composition was spray coated onto clean glass substrates and cured at 100° C. for 1 hour. Contact and roll-off angles, and coating integrity were measured on the coated samples as described above and are included in Table 2.

TABLE 2

| Example | CA | RA | Coating Integrity |
|---|---|---|---|
| 1 | 100 | >90 | 5 |
| 2 | 130 | >90 | 3 |
| 3 | 156 | 1.6–3.5 | 3 |
| 4c | 156 | 0.7–2.8 | 3 |

### EXAMPLE 5

Example 3 was repeated on a batch of samples under identical conditions to confirm the reproducibility of the results. Characterization data are included in Table 3. Surface roughness was measured using DEKTAK 8 advanced development profiler (Veeco Instruments).

TABLE 3

| Batch number | Sample | CA | RA | Roughness (μm) |
|---|---|---|---|---|
| 1 | 1 | 156 | 2.6 ± 0.9 | — |
| 2 | 1 | 157 | 2.6 ± 1.1 | 3.00 ± 0.13 |
| 3 | 1 | 156 | 1.4 ± 0.5 | 1.38 ± 0.08 |
| | 2 | 156 | 1.6 ± 0.8 | 3.73 ± 0.15 |
| | 3 | 156 | 1.3 ± 0.8 | 3.14 ± 0.05 |
| 4 | 1 | 154 | 2.6 ± 0.8 | — |
| | 2 | 157 | 2.2 ± 0.5 | 3.43 ± 0.22 |
| | 3 | 155 | 3.4 ± 0.6 | — |
| | 4 | 155 | 2.5 ± 1.2 | — |
| | 5 | 155 | 1.9 ± 1.7 | 3.34 ± 0.23 |
| 5 | 1 | 155 | 2.2 ± 1.4 | 3.35 ± 0.01 |
| | 2 | 155 | 1.6 ± 0.8 | — |
| | 3 | 156 | 1.4 ± 0.5 | 2.89 ± 0.12 |
| | 4 | 157 | 2.2 ± 1.1 | — |

The data of Table 3 show that the characteristics of the coating composition can be readily reproduced.

### EXAMPLE 6

Example 4 was repeated on a batch of samples prepared under identical conditions and by different operators to confirm the repeatability of the results. Characterization data are included in Table 4.

TABLE 4

| | | | | | Roughness |
|---|---|---|---|---|---|
| | | Sample | CA | RA | (μm) |
| Batch | Batch 1 | 1 | 156 | 1.2 ± 0.6 | 2.40 ± 0.27 |
| variation | | 2 | 156 | 0.9 ± 0.6 | 1.11 ± 0.16 |
| | | 3 | 155 | 1.0 ± 0.5 | 1.64 ± 0.57 |
| | Batch 2 | 1 | 157 | 1.1 ± 0.4 | 0.94 ± 0.10 |
| | | 2 | 155 | 1.1 ± 0.6 | 2.44 ± 0.52 |
| | | 3 | 156 | 1.1 ± 0.3 | 1.84 ± 0.97 |
| Process | Operator 1 | 1 | 155 | 1.2 ± 0.4 | 1.59 ± 0.76 |
| operator | | 2 | 154 | 1.9 ± 2.3 | 2.33 ± 0.65 |
| variation | | 3 | 156 | 1.2 ± 0.2 | 2.97 ± 0.85 |
| | Operator 2 | 1 | 155 | 0.9 ± 0.6 | 2.02 ± 0.61 |
| | | 2 | 154 | 1.8 ± 0.4 | 2.86 ± 1.05 |
| | | 3 | 155 | 2.8 ± 2.7 | 1.17 ± 0.29 |

The data of Table 4 show that the characteristics of the coating composition can be readily reproduced.

### EXAMPLE 7

Further experiments were conducted on fluoropolymer-1 combined with functionalized colloidal silica system to evaluate the influence of particle size, particle functionalization, and particle loading in a coating on a clean glass substrate. The results are given in Table 5.

TABLE 5

| | Particle | | | | | |
|---|---|---|---|---|---|---|
| Loading | size | Functional | | | Abrasion | Roughness |
| Volume | (nm) | groups | CA | RA | rating | (μm) |
| 1% | 90 | untreated | 88 | 90 | 5 | 0.14 |
| 30% | 90 | untreated | 89 | 90 | 4 | 1.4 |
| 60% | 90 | untreated | 129 | 90 | 3 | 2.6 |
| 85% | 90 | untreated | 123 | 90 | 1 | 1.4 |
| 1% | 340 | untreated | 87 | 90 | 5 | 0.2 |
| 30% | 340 | untreated | 89 | 90 | 5 | 0.5 |
| 60% | 340 | untreated | 152 | 19 | 2 | 11.9 |
| 85% | 340 | untreated | 156 | 12 | 1 | 1.98 |
| 1% | 1450 | untreated | 91 | 90 | 5 | 0.26 |
| 30% | 1450 | untreated | 90 | 90 | 4 | 1.0 |
| 60% | 1450 | untreated | 152 | 34 | 2 | 6.4 |
| 85% | 1450 | untreated | 154 | 12 | 1 | 4.4 |
| 1% | 90 | CH₃ | 87 | 90 | 5 | 0.27 |
| 30% | 90 | CH₃ | 97 | 90 | 5 | 0.28 |
| 60% | 90 | CH₃ | 156 | 80 | 4 | 0.89 |
| 85% | 90 | CH₃ | 157 | 1 | 1 | 2.4 |
| 1% | 340 | CH₃ | 87 | 90 | 5 | 0.33 |
| 30% | 340 | CH₃ | 91 | 90 | 5 | 0.81 |
| 60% | 340 | CH₃ | 157 | 5 | 2 | 4.4 |
| 85% | 340 | CH₃ | 156 | 2 | 1 | 1.1 |
| 1% | 1450 | CH₃ | 88 | 90 | 5 | 0.20 |
| 30% | 1450 | CH₃ | 92 | 90 | 4 | 1.6 |
| 60% | 1450 | CH₃ | 155 | 9 | 2 | 7.45 |
| 85% | 1450 | CH₃ | 158 | 2 | 1 | 1.25 |
| 1% | 90 | Fluoro | 87 | 90 | 5 | 0.22 |
| 30% | 90 | Fluoro | 91 | 90 | 5 | 0.63 |
| 60% | 90 | Fluoro | 152 | 10 | 3 | 2.9 |
| 85% | 90 | Fluoro | 159 | 4 | 1 | 2.3 |
| 1% | 340 | Fluoro | 91 | 90 | 5 | 0.14 |
| 30% | 340 | Fluoro | 109 | 90 | 4 | 0.61 |
| 40% | 340 | Fluoro | 106 | 90 | 4 | — |
| 50% | 340 | Fluoro | 140 | 90 | 3 | — |
| 60% | 340 | Fluoro | 155 | 1 | 3 | 1.6 |
| 85% | 340 | Fluoro | 154 | 1 | 1 | 8.65 |
| 1% | 1450 | Fluoro | 93 | 90 | 5 | 0.23 |
| 30% | 1450 | Fluoro | 120 | 90 | 4 | 0.67 |
| 40% | 1450 | Fluoro | 128 | 90 | 3 | — |
| 50% | 1450 | Fluoro | 159 | 10 | 2 | — |
| 60% | 1450 | Fluoro | 156 | 1 | 3 | 6.10 |
| 85% | 1450 | Fluoro | 163 | 1 | 1 | 4.51 |

The data in Table 5 show that coatings with silica particles having median particle size of 340 nm and 1450 nm typically gave lower roll-off angle (better hydrophobicity) than the coatings with particles having median particle size of 90 nm. Higher particle loading typically resulted in better hydrophobicity in some embodiments when the particle loading was 30 vol. % or greater.

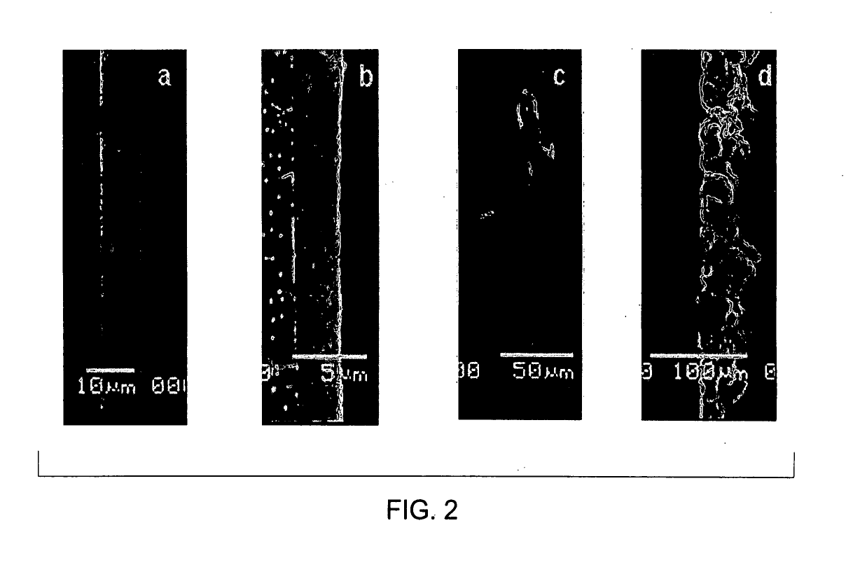

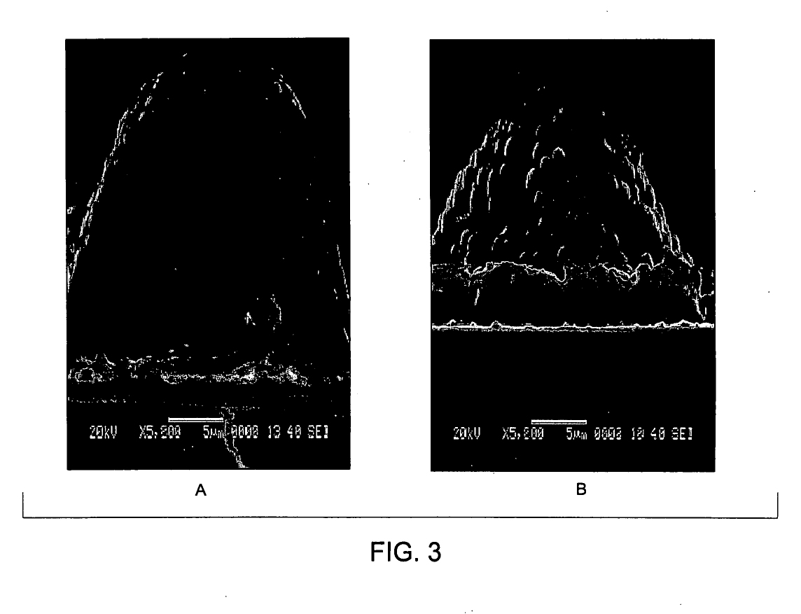

The cross sectional scanning electron images of coatings comprising 340 nm fluoro-functionalized silica particles with different particle loadings are shown in FIG. 2. FIGS. 2a, 2b, 2c, and 2d show 1 vol. %, 30 vol. %, 60 vol. %, and 85 vol. % particle loading, respectively. From these images, it is clear that as the particle loading increased, the roughness of the coating increased resulting in increased contact angle. For fluoro-coatings comprising other particles, the trends were generally the same. FIG. 3 shows scanning electron micrographs of the coating comprising untreated 1450 nm particles (FIG. 3a) and fluoro-functionalized 1450 nm particles at 30 vol. % particle loading (FIG. 3b). The fluoro-functionalized particles provided hierarchical roughness and this hierarchical roughness contributed to higher contact angle.

The data of Table 5 show that particle loading has an effect on the coating integrity. With the higher particle loading, the coating integrity decreased. When the particle loading was 85 vol. %, the coating integrity of all the coatings was poor. There is a trade-off between coating superhydrophobicity and coating integrity. The coating integrity was independent of the functional group on the particle.

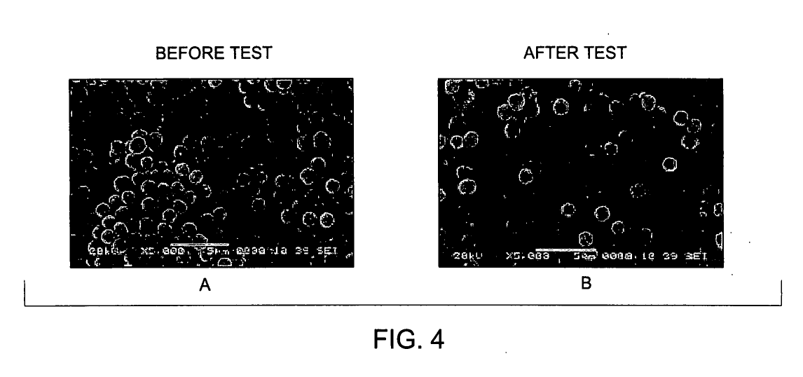

After the cotton swab abrasion test, the samples showing superhydrophobicity were chosen to check the water droplet roll-off behavior at the abraded area. Rating 1 to 3 was assigned to each coating. The rating criteria are as follows: Rating 1—after abrasion, the area was wetted by water droplets; Rating 2—after abrasion, the area was not wetted by water droplets but the water droplets do not roll-off; Rating 3—after abrasion, the water droplet rolls off of the area. Rating 3 implies the best roll-off behavior and rating 1 implies the worst roll-off behavior. The scanning electron micrograph of a coating comprising 1450 nm particles at particle loading of 60% before and after abrasion is shown in FIG. 4. After abrasion, the coating showed good roll-off behavior and from the micrograph it was clear that the structure visible after the abrasion was essentially identical to the structure at the top surface implying that the surface is a regenerable surface and hence these coatings may be suitable for use outdoors or in a high wear environment.

### EXAMPLE 8

Octyl-functionalized colloidal silica of about 340 nm particle size was prepared as follows: 100 g of colloidal silica synthesized in toluene (silica concentration: 12%, pure weight of silica: 12 g) and 100 g dichloromethane were charged into a 250 ml flask; then the mixture was stirred at room temperature, and an excess of octylmethyldichlorosilane (1.77 g, 7.mmol) was added. The mixture was stirred at room temperature for about 20 hours, then centrifuged at a speed of 6000 rpm. The precipitated silica particles were collected and dispersed in dichloromethane with the help of ultrasound, then centrifuged again. The same centrifugation-dispersion procedure was repeated five times. Finally, the synthesized octyl-functionalized colloidal silica was dispersed in methylisobutylketone with the weight concentration of 13.7%. Similar processes were adopted to synthesize octyl-functionalized colloidal silica with the particle size of 90 nm and 1450 nm.

### EXAMPLE 9

Further experiments were conducted on fluoropolymer-1 and fluoropolymer-2 combined with functionalized colloidal silica to evaluate the influence of particle size, particle functionalization, and particle loading in a coating on a clean glass substrate. The results are given in Table 6.

TABLE 6

| Fluoro- | Loading | Particle | Functional | | | Abrasion |
|---|---|---|---|---|---|---|
| polymer | Volume | size (nm) | groups | CA | RA | rating |
| 1 | 60% | 810 | octyl | 156 | 2 | 3 |
| 1 | 60% | 890 | fluoro | 159 | 2 | 3 |
| 2 | 50% | 340 | fluoro | 112 | 90 | 3 |
| 2 | 60% | 340 | fluoro | 157 | 2 | 3 |

The data in Table 6 show that a coating comprising fluoropolymer-1 and silica particles having median particle size of around 800 nm at 60% loading gave high contact angle and low roll-off angle (good hydrophobicity). The data also show that a coating comprising fluoropolymer-2 and silica particles having median particle size of 340 nm at 60% loading gave higher contact angle and lower roll-off angle (better hydrophobicity) than the similar coating at 50% loading.

While only certain features of the invention have been illustrated and described herein, many modifications and changes will occur to those skilled in the art. It is, therefore, to be understood that the appended claims are intended to cover all such modifications and changes as fall within the true spirit of the invention. All patents and published patent applications cited in this application are incorporated herein by reference.

1. A coating composition comprising: (i) a fluorinated polymer comprising (a) structural units having the formula (I):
—CR¹R²—CFX— (I)
wherein R¹ and R² are each independently an alkyl group, a fluorine atom, a chlorine atom, a hydrogen atom or a trifluoromethyl group, and X is a fluorine atom, a chlorine atom, a hydrogen atom or a trifluoromethyl group, and (b) structural units comprising at least one type of crosslinkable functional group; (ii) a crosslinking agent; and (iii) a plurality of particles functionalized with a functional group, wherein the functional group on the particles is essentially non-reactive with the fluorinated polymer and with the crosslinking agent.

2. The coating composition of claim 1, wherein the polymer comprises a fluorine content in a range from about 5 wt. % to about 60 wt. %, a hydroxyl value in a range from about 10 milligrams potassium hydroxide per gram (mg KOH/g) to about 200 mg KOH/g, and an acid value in a range from about 0 mg KOH/g to about 15 mg KOH/g.

3. The coating composition of claim 1, wherein the fluorinated polymer comprises structural units derived from at least one monomer selected from the group consisting of CF₂═CF₂, CHF═CF₂, CH₂═CF₂, CH₂═CHF, CClF═CF₂, CCl₂═CF₂, CClF═CClF, CHF═CCl₂, CH₂═CClF, CCl₂═CClF, CH₂═C(CF₃)₂, CF₃CF═CF₂, CF₃CF═CHF, CF₃CH═CF₂, CF₃CH═CH₂, CHF₂CF═CHF, CHF₂CH═CHF, CHF₂CH═CH₂, and mixtures thereof.

4. The coating composition of claim 1, wherein the crosslinkable functional group is selected from the group consisting of a hydroxyl group, an amine group, a carboxylic ester, a sulfonyl halide, a carboxylic acid, and mixtures thereof.

5. The coating composition of claim 1, wherein the crosslinkable functional group is derived from at least one monomer selected from the group consisting of an unsaturated carboxylate ester, an unsaturated carboxylic acid, a vinyl ester, a hydroxylated vinyl derivative, an allyl alcohol, a vinyl alcohol, a propenol, a butenol, 2-hydroxy-ethyl-methacrylate, a hydroxyalkyl vinyl ether or hydroxyalkyl allyl ether represented by the formula (II):
CH₂═CHR¹ (II)
wherein R¹ is —OR² or —CH₂OR² in which R² is an alkyl group having a hydroxyl group, 2-hydroxyethyl vinyl ether, 3-hydroxypropyl vinyl ether, 2-hydroxypropyl vinyl ether, 2-hydroxy-2-methylpropyl vinyl ether, hydroxybutyl vinyl ether, 4-hydroxybutyl vinyl ether, 4-hydroxy-2-methylbutyl vinyl ether, 5-hydroxypentyl vinyl ether, 6-hydroxyhexyl vinyl ether, 2-hydroxyethyl allyl ether, hydroxybutyl allyl ether, 4-hydroxybutyl allyl ether, glycerol monoallyl ether, and mixtures thereof.

6. The coating composition of claim 1, wherein the fluorinated polymer further comprises structural units derived from one or more monomers having ester moieties and comprising those represented by the formula (III):
CHR³═CHR⁴ (III)
wherein R³ is a hydrogen atom, an alkyl group, or —COOR⁵, R⁴ is —COOR⁵ or —OCOR⁵, in which R⁵ is an alkyl group, a cycloalkyl group, a fluoroalkyl group, an arylalkyl group or an aryl group which may be substituted by an alkyl group; provided that when R⁴ is —OCOR⁵, R³ is a hydrogen atom.

7. The coating composition of claim 1, wherein the fluorinated polymer further comprises structural units derived from one or more monomers having carboxylic acid moieties and comprising those represented by the formula (VII):
R⁶R⁷C═CR⁸(CH₂)_{y}CO₂H (VII)
wherein R⁶, R⁷ and R⁸ are the same or different, and each is independently a hydrogen atom, a fluorine atom, an alkyl group, an aryl group, a carboxyl or an ester group, and y has a value in a range from 0 to about 10; or represented by the formula (VIII):
CH₂═CH(CH₂)ₘO(R⁹OCO)ₙR¹⁰CO₂H (VIII)
wherein R⁹ and R¹⁰ are same or different, and each is a linear or a cyclic alkyl which may be saturated or unsaturated, n is 0 or 1, and m is 0 or 1.

8. The coating composition of claim 1, wherein the crosslinking agent comprises an isocyanate group, a divinyl group, an ester group, an acid halide group, a sulfonyl halide group, an organosilane, a epoxy group, an oxetanyl group, an oxazolyl group, an amino group, a mercapto group, a ketoester group, a hydrosilyl group, a silanol group, or a sulfonyl ester group.

9. The coating composition of claim 7, wherein the crosslinking agent comprises an isocyanate group.

10. The coating composition of claim 1, wherein the particles comprise a material selected from the group consisting of a ceramic, a polymer, a semiconducting material, a polyorganosilsesquioxane, a metal, a metal oxide, a natural or a synthetic mineral, a natural or a synthetic clay, an inorganic material, and a glass particle.

11. The coating composition of claim 9, wherein the ceramic comprises at least one material selected from the group consisting of silica, titania, zinc oxide, alumina, zirconia, vanadia, chromia, ceria, iron oxide, antimony oxide, tin oxide, boron nitride, aluminosilicates, talc, graphite, carbon black, hydrolyzed graphite, and mixtures thereof.

12. The coating composition of claim 9, wherein the polymer comprises a crosslinked polylolefin, a crosslinked polybutadiene, a crosslinked polystyrene, polytetrafluoroethylene, polypropylene, polyethylene, poly(fluorinated ethylene vinyl ether), a fluorinated polyacrylate, a fluorinated polyether, a fluorinated polyurethane, a fluorinated epoxy resin, a fluorinated silicone, a fluorinated alkyd resin, a fluorinated polyurea, or a fluorinated formaldehyde phenol resin.

13. The coating composition of claim 1, wherein the particles comprise silica or a polyorganosilsesquioxane.

14. The coating composition of claim 1, wherein the functional group on the particles is selected from the group consisting of a fluoro group, an alkyl group, a cycloalkyl group, an aryl group, and a silyl group.

15. The coating composition of claim 1, wherein the functional group on the particles comprises a fluoro group.

16. The coating composition of claim 1, wherein the coating composition after coating onto a surface has a wettability sufficient to generate, with a reference fluid, a static contact angle of greater than about 120 degrees.

17. The coating composition of claim 1, wherein the coating composition after coating onto a surface has a wettability of sufficient to generate, with a reference fluid, a static contact angle of greater than about 140 degrees.

18. The coating composition of claim 1, wherein the coating composition after coating onto a surface has a wettability sufficient to generate, with a reference fluid, a roll-off angle of less than about 10 degrees.

19. A coating composition comprising (i) a fluorinated polymer comprising structural units derived from at least one monomer selected from the group consisting of CF₂═CF₂, CHF═CF₂, CH₂═CF₂, CH₂═CHF, CClF═CF₂, CCl₂═CF₂, CClF═CClF, CHF═CCl₂, CH₂═CClF, CCl₂═CClF, CH₂═C(CF₃)₂, CF₃CF═CF₂, CF₃CF═CHF, CF₃CH═CF₂, CF₃CH═CH₂, CHF₂CF═CHF, CHF₂CH═CHF, CHF₂CH═CH₂, and mixtures thereof, and further comprising structural units comprising a crosslinkable hydroxyl functional group; (ii) a crosslinking agent comprising an isocyanate; and (iii) a plurality of silica particles or polyorganosilsesquioxane particles functionalized with a fluoro group or an alkyl group;
wherein the polymer comprises a fluorine content in a range from about 5 wt. % to about 60 wt. %, a hydroxyl value in a range from about 10 mg KOH/g to about 100 mg KOH/g, and an acid value in a range from about 0 mg KOH/g to about 15 mg KOH/g, wherein the coating, after coating onto a surface, has a wettability sufficient to generate, with a reference fluid, a static contact angle of greater than about 120 degrees.

20. An article comprising the coating composition of claim 1.

21. An article comprising the coating composition of claim 18.

22. An article comprising a coating composition comprising: (i) a fluorinated polymer comprising (a) structural units having the formula (I):
—CR¹R²—CFX— (I)
wherein R¹ and R² are each independently an alkyl group, a fluorine atom, a chlorine atom, a hydrogen atom or a trifluoromethyl group, and X is a fluorine atom, a chlorine atom, a hydrogen atom or a trifluoromethyl group, and (b) structural units comprising at least one type of crosslinkable functional group; (ii) a crosslinking agent; and (iii) a plurality of particles functionalized with a functional group, wherein the functional group on the particles is essentially non-reactive with the fluorinated polymer and with the crosslinking agent.

23. The article of claim 22, wherein the polymer comprises a fluorine content in a range from about 5 wt. % to about 60 wt. %, a hydroxyl value in a range from about 10 milligrams potassium hydroxide per gram (mg KOH/g) to about 200 mg KOH/g, and an acid value in a range from about 0 mg KOH/g to about 15 mg KOH/g.

24. The article of claim 22, wherein the fluorinated polymer comprises structural units derived from at least one monomer selected from the group consisting of CF₂═CF₂, CHF═CF₂, CH₂═CF₂, CH₂═CHF, CClF═CF₂, CCl₂═CF₂, CClF═CClF, CHF═CCl₂, CH₂═CClF, CCl₂═CClF, CH₂═C(CF₃)₂, CF₃CF═CF₂, CF₃CF═CHF, CF₃CH═CF₂, CF₃CH═CH₂, CHF₂CF═CHF, CHF₂CH═CHF, CHF₂CH═CH₂, and mixtures thereof.

25. The article of claim 22, wherein the crosslinkable functional group is selected from the group consisting of a hydroxyl group, an amine group, a carboxylic ester, a sulfonyl halide, a carboxylic acid, and mixtures thereof.

26. The article of claim 22, wherein the crosslinkable functional group is derived from at least one monomer selected from the group consisting of an unsaturated carboxylate ester, an unsaturated carboxylic acid, a vinyl ester, a hydroxylated vinyl derivative, an allyl alcohol, a vinyl alcohol, a propenol, a butenol, 2-hydroxy-ethyl-methacrylate, a hydroxyalkyl vinyl ether or hydroxyalkyl allyl ether represented by the formula (II):
CH₂═CHR¹ (II)
wherein R¹ is —OR² or —CH₂OR² in which R² is an alkyl group having a hydroxyl group, 2-hydroxyethyl vinyl ether, 3-hydroxypropyl vinyl ether, 2-hydroxypropyl vinyl ether, 2-hydroxy-2-methylpropyl vinyl ether, hydroxybutyl vinyl ether, 4-hydroxybutyl vinyl ether, 4-hydroxy-2-methylbutyl vinyl ether, 5-hydroxypentyl vinyl ether, 6-hydroxyhexyl vinyl ether, 2-hydroxyethyl allyl ether, hydroxybutyl allyl ether, 4-hydroxybutyl allyl ether, glycerol monoallyl ether, and mixtures thereof.

27. The article of claim 22, wherein the fluorinated polymer comprises structural units derived from one or more monomers having ester moieties and comprising those represented by the formula (III):
CHR³═CHR⁴ (III)
wherein R³ is hydrogen atom, an alkyl group, or —COOR⁵, R⁴ is —COOR⁵ or —OCOR⁵, in which R⁵ is an alkyl group, a cycloalkyl group, a fluoroalkyl group, an arylalkyl group or an aryl group which may be substituted by an alkyl group; provided that when R⁴ is —OCOR⁵, R³ is a hydrogen atom.

28. The article of claim 22, wherein the fluorinated polymer comprises structural units derived from one or more monomers having carboxylic acid moieties and comprising those represented by the formula (VII):
R⁶R⁷C═CR(CH₂)_{y}CO₂H (VII)
wherein R⁶, R⁷ and R⁸ are the same or different, and each is independently a hydrogen atom, a fluorine atom, an alkyl group, an aryl group, a carboxyl or an ester group, and y has a value in a range from 0 to about 10; or represented by the formula (VIII):
CH₂═CH(CH₂)ₘO(R⁹OCO)ₙR¹⁰CO₂H (VIII)
wherein R⁹ and R¹⁰ are same or different, and each is a linear or a cyclic alkyl which may be saturated or unsaturated, n is 0 or 1, and m is 0 or 1.

29. The article of claim 22, wherein the crosslinking agent comprises an isocyanate group, a divinyl group, an ester group, an acid halide group, a sulfonyl halide group, an organosilane, a epoxy group, an oxetanyl group, an oxazolyl group, an amino group, a mercapto group, a β-ketoester group, a hydrosilyl group, a silanol group, or a sulfonyl ester group.

30. The article of claim 29, wherein the crosslinking agent comprises an isocyanate group.

31. The article of claim 22, wherein the particles comprise a material selected from the group consisting of a ceramic, a polymer, a semiconducting material, a polyorganosilsesquioxane, a metal, a metal oxide, a natural or a synthetic mineral, a natural or a synthetic clay, an inorganic material, and a glass particle.

32. The article of claim 31, wherein the ceramic comprises at least one material selected from the group consisting of silica, titania, zinc oxide, alumina, zirconia, vanadia, chromia, ceria, iron oxide, antimony oxide, tin oxide, boron nitride, aluminosilicates, talc, graphite, carbon black, hydrolyzed graphite, and mixtures thereof.

33. The article of claim 31, wherein the polymer particles comprise a crosslinked polylolefin, a crosslinked polybutadiene, a crosslinked polystyrene, polytetrafluoroethylene, polypropylene, polyethylene, poly(fluorinated ethylene vinyl ether), a fluorinated polyacrylate, a fluorinated polyether, a fluorinated polyurethane, a fluorinated epoxy resin, a fluorinated silicone, a fluorinated alkyd resin, a fluorinated polyurea, or a fluorinated formaldehyde phenol resin.

34. The article of claim 22, wherein the particles comprise silica or a polyorganosilsesquioxane.

35. The article of claim 22, wherein the functional group on the particles is selected from the group consisting of a fluoro group, an alkyl group, a cycloalkyl group, an aryl group, and a silyl group.

36. The article of claim 22, wherein the functional group on the particles comprises a fluoro group.

37. The article of claim 22, wherein the coating composition, after coating onto a surface, has a wettability sufficient to generate, with a reference fluid, a static contact angle of greater than about 120 degrees.

38. The article of claim 22, wherein the coating composition, after coating onto a surface, has a wettability of sufficient to generate, with a reference fluid, a static contact angle of greater than about 140 degrees.

39. The article of claim 22, wherein the coating composition, after coating onto a surface, has a wettability sufficient to generate, with a reference fluid, a roll-off angle of less than about 100.

40. An article comprising a coating composition comprising (i) a fluorinated polymer comprising structural units derived from at least one monomer selected from the group consisting of CF₂═CF₂, CHF═CF₂, CH₂═CF₂, CH₂═CHF, CClF═CF₂, CCl₂═CF₂, CClF═CClF, CHF═CCl₂, CH₂═CClF, CCl₂═CClF, CH₂═C(CF₃)₂, CF₃CF═CF₂, CF₃CF═CHF, CF₃CH═CF₂, CF₃CH═CH₂, CHF₂CF═CHF, CHF₂CH═CHF, CHF₂CH═CH₂, and mixtures thereof, and further comprising structural units comprising a crosslinkable hydroxyl functional group; (ii) a crosslinking agent comprising an isocyanate; and (iii) a plurality of silica particles or polyorganosilsesquioxane particles functionalized with a fluoro group or an alkyl group;
wherein the polymer comprises a fluorine content in a range from about 5 wt. % to about 60 wt. %, a hydroxyl value in a range from about 10 mg KOH/g to about 100 mg KOH/g, and an acid value in a range from about 0 mg KOH/g to about 15 mg KOH/g, wherein the coating has a wettability after coating onto a surface sufficient to generate, with a reference fluid, a static contact angle of greater than about 120 degrees.
